(19) United States
(12) Patent Application Publication
(10) Pub. No.: US 2023/0193590 A1
(43) Pub. Date: Jun. 22, 2023

(54) WORK MACHINE

(71) Applicant: Liebherr-Werk Bischofshofen GmbH, Bischofshofen (AT)

(72) Inventors: Reinhard DENGG, Tamsweg (AT); Georg GANITZER, Flachau (AT); David SAGORZ, Bad Hofgastein (AT); Birgit KAINZ, St. Andrae-Woerdern (AT); Peter KAINZ, St. Andrae-Woerdern (AT)

(21) Appl. No.: 18/067,448

(22) Filed: Dec. 16, 2022

(30) Foreign Application Priority Data
Dec. 16, 2021 (DE) 10 2021 133 515.9

(51) Int. Cl. E02F 9/08; E02F 3/34

(52) U.S. Cl. CPC E02F 9/0883; E02F 3/34

(57) ABSTRACT

The present disclosure relates to a work machine having at least one container for receiving a fuel that serves the propulsion of the work machine and/or for the drive of a machine component, wherein an assembly is provided that comprises a rack in which the container is received and that furthermore has a plating for the mechanical protection of the container located in the rack.

### CROSS-REFERENCE TO RELATED APPLICATION

The present application claims priority to German Patent Application No. 10 2021 133 515.9 filed on Dec. 16, 2021. The entire contents of the above-listed application are hereby incorporated by reference for all purposes.

### TECHNICAL FIELD

The present disclosure relates to a work machine having at least on container for receiving a fuel that serves the propulsion of the work machine and/or for the drive of a machine component.

### BACKGROUND

On the arrangement of tank systems for gaseous energy carriers (such as compressed gaseous hydrogen) of a vehicle fuel system, the accommodation of a sufficient filling quantity is a very great challenge. In particular the accommodation of compressed gaseous hydrogen containers that are cylindrical as a rule requires great efforts to be able to utilize the existing construction space as much as possible and not to restrict the behavior with respect to travelability criteria and operability criteria. It is additionally aggravating that corresponding construction measures have to be provided at the vehicle for the mechanical protection of the hydrogen container in dependence on the installation site whose necessity is, on the one hand, due to the risk analysis of the vehicle manufacturer, but also to the analogous concept as part of a possible implementation of guidelines and regulations from the automotive sector.

### SUMMARY

It is known from the prior art in the passenger vehicle sector to accommodate natural gas tanks, but also hydrogen tanks, within the vehicle crash structure. The containers are, for example, arranged below the back seat or in the region of the underfloor. The crash structure of the vehicle body correspondingly advantageously acts as mechanical protection. The arrangement as a cylinder bundle behind the cabin is known in the truck sector, which should be advantageous for typical accident scenarios. In contrast, the arrangement in the truck in the plane of the chassis, outside the vehicle frame, between the axles appears less advantageous, which appears to be without any alternative due to the huge range requirement, however. Finally, hydrogen tank systems are known from the bus sector that are positioned on the roof and that have a very great similarity to the solutions for natural gas vehicles.

The aforesaid known approaches are unsuitable for wheeled loaders or for other work machines. All the construction space within the protected rear part of the vehicle frame connected by the articulated joint is taken up by drive technology such as the energy source, engines, transmissions, articulated shafts, and axles. An arrangement of the container or containers behind the cabin of the wheeled loader is only possible with limitations due to the accident and danger scenarios. This applies accordingly to the arrangement on the cabin roof of the wheeled loader, particularly since the space for the accommodation of hydrogen tanks on a wheeled loader cabin is extremely small in comparison with a bus and passage heights, but also transport heights, for low-load trucks would be hugely restricted.

It is the underlying object of the present disclosure to further develop a work machine of the initially named kind such that the demands on a high mechanical protection requirement (FOPS test) are also satisfied in the case of the work machine rolling over. It must in particular be ensured that the fuel container withstands all the forces that occur in the event of a rollover.

This object is achieved by a work machine having the features of claim 1.

An assembly is accordingly provided that comprises an installation frame in which the container or containers are received and that furthermore has plating for the mechanical protection of the container located in the installation frame.

The disclosure is thus based on the idea of providing an assembly that has an installation frame (“rack”) as a support framework for the reception of the containers and optionally to enable its deformation and that has a mechanical protective structure as the plating as a common component. It is, for example, conceivable that the plating is formed in the form of a sump or of a container sump or tank sump. It can, for example, consist of sheet metal or steel or also of a composite material such as GRP or CRP or of a combination of the aforesaid materials.

The container or containers are optionally arranged removably or exchangeably in or at the rack or at the assembly. The design of the work machine with and without a container and the design with the empty containers and with containers filled with fuel are claimed.

Examples for conceivable gaseous fuels include hydrogen, CNG, methane gas, and others; examples for fluid fuels include liquid hydrogen and liquid gas, e-fuels, and conventional diesel fuel.

It is pointed out that the term “rack” is not to be interpreted as restrictive such that it is a frame-like structure in the narrower sense. Any desired support structure or carrier structure is covered. The rack is also called a “tank sump” within the framework of the present disclosure.

The assembly thus combines two functions, namely the secure reception of the container or containers and the protective function for the containers. The solution is characterized by a particularly compact and space-saving installation with the possibility that the assembly has small distances from the adjacent parts of the work machine.

In a further aspect, the disclosure relates to a work machine having the features of claim 2. Provision is accordingly made that a rack is provided in which the container is arranged and that a pivot or folding mechanism is present by means of which the rack is arranged pivotably or foldingly at the work machine.

The installation position of the tank sump or of the rack can be temporarily changed by a pivot or folding mechanism so that the maintenance possibility for the hydrogen tank system or for another container system, but also for the adjacent components can be made possible particularly easily due to the space-saving installation and the pivotability.

It is, for example, conceivable that the assembly can be pivoted away from the work machine, for example to be able to carry out a replacement of a container or to be able to carry out a repair or servicing of the container or tank system or of another part of the work machine.

In a further aspect, the disclosure relates to a work machine having the features of claim 3. Provision is accordingly made that a rack is provided in which the container or containers is/are arranged and that the rack is arranged above the wheel arch or arches.

The arrangement of the containers behind the cabin of the work machine is only possible with limitations due to the accident and danger scenarios. As stated above, the arrangement on the roof of the cabin of the work machine is associated with disadvantages. The arrangement above one or more wheel arches (at one side or at both sides) is particularly advantageous since; on the one hand, good accessibility to the container or containers is ensured and the disadvantages associated with the arrangement on the cabin roof are avoided (problems with regard to the passage height, the transport height for the low-loader transport, insufficient stability in the event of a rollover, etc.).

The arrangement optionally directly above or spaced apart above the wheel arch or arches is also advantageous in that the view of the machine operator in the cabin is not or is not substantially restricted.

For example, the rear wheel arches of the wheeled loader or of another work machine, and in an extension the ballast weights, are suitable as the attachment or installation site and to form the container installation as a tank sump or the like arranged thereabove. Depending on the vehicle size, the tank sump or the assembly can be arranged at one side or at both sides and can be equipped with one or more horizontal or standing containers.

An arrangement of this assembly as tightly as possible to the adjacent engine room, in which e.g. a fuel cell, but also a hydrogen reciprocal piston engine, can be accommodated as the energy source, optionally permits the maintenance of the field of view of the operator to the vehicle rear when looking over the shoulder when reversing.

The pivot and folding mechanism makes it possible to be able to arrange the tank sump or assembly as close as possible to the engine room without the maintenance accessibility being impaired by this compact arrangement.

The present disclosure also covers a work machine having any desired combination of the features of one or more of the claims 1, 2, and 3.

The tank sump or the assembly is optionally designed to protect the container or containers from fire.

In a further development of the disclosure, a fixed position fuel pipeline system is present and a flexible sump piece is provided that connects this fixed position pipeline system to the container or to the rack. A problem-free folding or pivoting is thus possible without the connection between the fixedly arranged components and the foldable or pivotable parts of the fuel system having to be released.

The transition of the hydrogen lines or other fuel lines from the movable part or parts of the tank system to the standing pipeline system fixed to the vehicle is thus optionally designed with a flexible tube piece.

It is conceivable that the pivot or folding mechanism is either manually movable and/or that a mechanism is present to actuate the pivot or folding mechanism that is supported by external force. The pivot or folding mechanism can thus be actuated either by muscular strength or by a mechanism supported by external force such as by means of gas springs, electric lifting spindles, or the like, hydraulic and/or pneumatic cylinders, etc.

The axis about which the pivot or folding mechanism is pivotable can extend horizontally, vertically, or obliquely

The folding away and outwardly pivoting mechanism can have corresponding end abutments and/or latches with the latter having the purpose of fixing the container arrangement in the desired position.

As stated above, the rack can be configured to receive a mechanical deformation of the container

The tank sump can be designed as a preinstallation assembly.

It can be composed of a plurality of individual parts as an assembly.

It is also conceivable that the rack and the mechanical protection are designed in a single component, i.e. in one part.

The fuel system can have a high pressure part, with all the components of the high pressure part optionally being arranged in the rack or in the assembly The tank sumps advantageously include all the components of the high pressure part, including the pressure regulator, so that the flexible lines are components of the central pressure path of the gas or fuel path of the vehicle fuel system.

The container can serve the reception of a gaseous fuel and/or the reception of a fluid fuel or can be filled therewith

The work machine is optionally a travelable work machine and in particular a wheeled loader or related machine categories or articulately linked work machines, a crawler excavator and wheeled excavator, an articulately linked dump truck and a rigid frame dumper, or a telescopic loader.

The work machine can have a fuel cell or an internal combustion engine such as a hydrogen reciprocal piston engine for the propulsion of the work machine.

It is pointed out at this point that the terms “a” and “one” do not necessarily refer to exactly one of the elements, even though this represents a possible embodiment, but can also designate a plurality of elements. The use of the plural equally also includes the presence of the element in question in the singular and, conversely, the singular also includes a plurality of the elements in question.

Further details and advantages of the disclosure will be explained in more detail with reference to an embodiment shown in the drawing.

### BRIEF DESCRIPTION OF THE FIGURES

There are shown:

FIG. 1: a plan view of a wheeled loader in accordance with the disclosure with tanks arranged as standing;

FIG. 2: a rear view of the wheeled loader in accordance with FIG. 1 with an inwardly folded tank sump;

FIG. 3: a rear view of the wheeled loader in accordance with FIG. 1 with an inwardly folded tank sump;

FIG. 4: a plan view of a wheeled loader in accordance with the disclosure with tanks arranged as standing;

FIG. 5: a rear view of the wheeled loader in accordance with FIG. 4,

FIG. 6: a rear view of a wheeled loader with tanks arranged horizontally with an inwardly folded tank sump;

FIG. 7: a rear view of the wheeled loader in accordance with FIG. 6 with an outwardly folded tank sump; and

FIG. 8: a plan view of a wheeled loader with a tank arrangement pivotable about a vertical axis.

### DETAILED DESCRIPTION

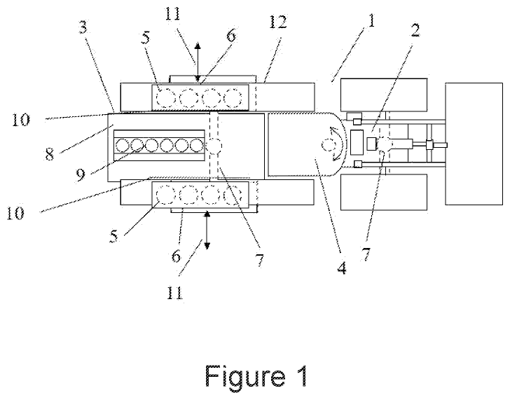

FIG. 1 shows a peritoneal dialysis system in accordance with the disclosure in a plan view. The wheel loader has a front part 2 and a rear part 3 that are connected pivotably relative to one another by an articulated joint.

The cabin of the wheeled loader is marked by reference numeral 4.

Reference numeral 5 marks fuel containers or tanks arranged as standing. The tanks arranged as standing next to one another are located in a protective structure and a rack 6. This arrangement is located, as can be seen from FIG. 1, on both sides of the rear wheel arches 12 of the wheeled loader 1 in each case. The term “over” or “above” does not require the tank sump or the rack to be located exactly above the wheel arches; a lateral offset is also covered by the disclosure.

The rear and front drive axles are marked by 7 and the engine room by 8. Reference numeral 9 marks the energy source e.g. in the form of a fuel cell or of an internal combustion engine.

The tank system or the tank sump or assembly group is pivotable about the horizontally extending axis 10 to ensure good accessibility to both the tank system and the parts of the work machine behind these parts in the inwardly folded regions. 11 marks the pivot range of the tank system.

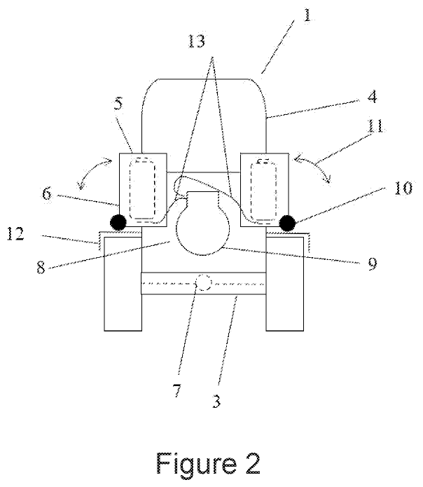

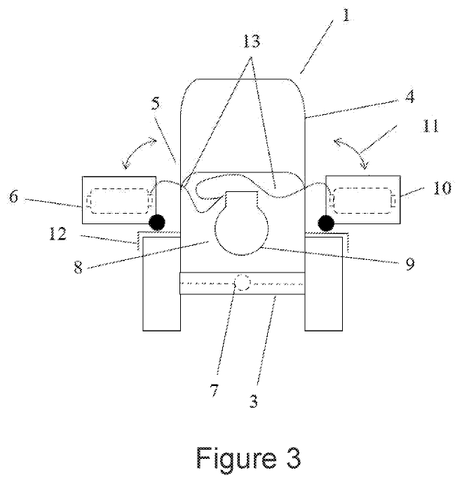

FIG. 2 shows the wheeled loader in accordance with FIG. 1 in a rear view with a folded back rack or with folded back tank sumps and FIG. 3 shows it with unfolded rack or tank sumps.

Elements that are the same or that have the same function are provided with the same reference numerals in the Figures, with reference numeral 5 relating both to the tanks per se and to the tank sump or rack.

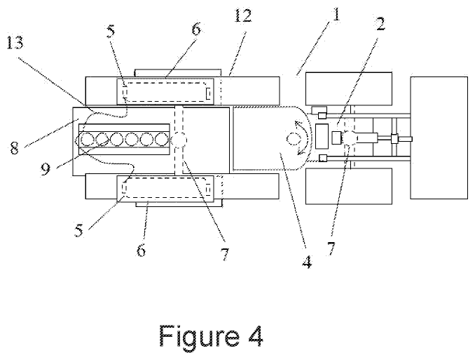

A plan view of a wheeled loader in accordance with the disclosure with horizontal tanks 5 can be seen from FIG. 4. One or more tanks 5 arranged above one another can be used. The fuel containers, i.e. the tanks 5, are also arranged above the wheel wells 12 in this version. The tank arrangement is not arranged pivotably in this embodiment

13 marks a supply line that serves the supply of the internal combustion engine or of the fuel cell, etc. with fuel, e.g. with hydrogen.

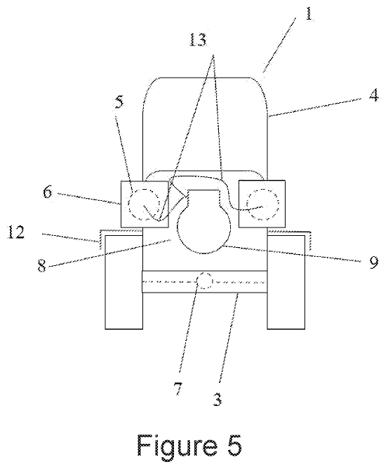

FIG. 5 is a rear view of a version of the wheeled loader in accordance with FIG. 4.

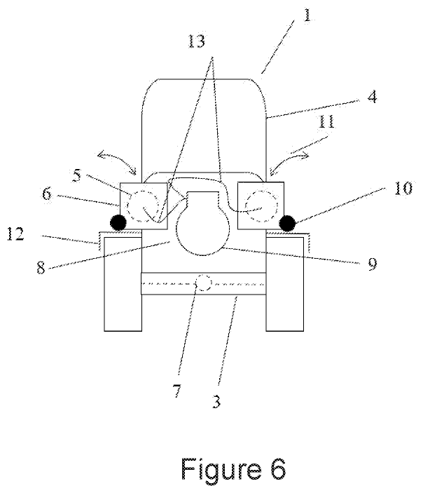

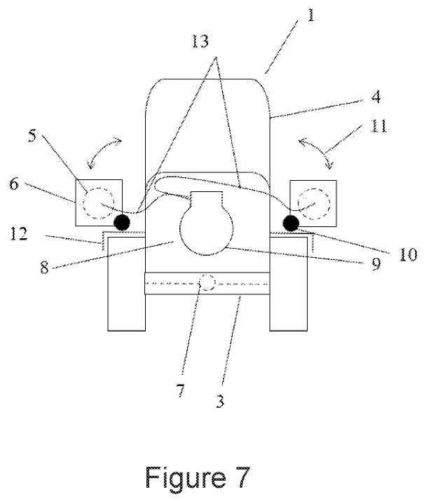

A rear view of a version of a wheeled loader 1 is shown in FIG. 6 in which the tank sump with the tanks 5 lying therein or the rack being pivotable about a horizontally extending axis 10. FIG. 6 shows the arrangement in the inwardly folded state of the tank sump 5. FIG. 7 shows the wheeled loader in accordance with FIG. 6 with an outwardly folded tank sump 5. Reference numeral 11 designates the pivot range of the tank system.

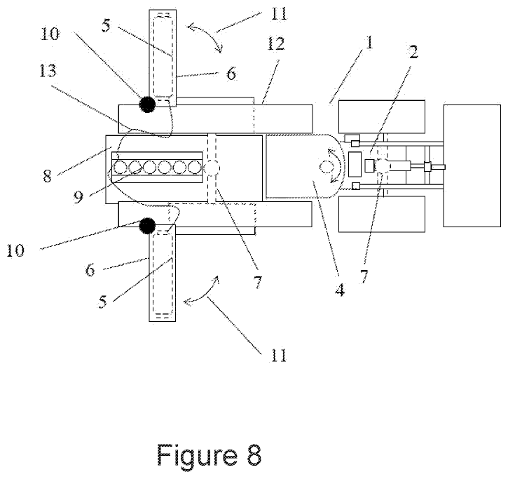

The embodiment in accordance with FIG. 8 shows a plan view of the wheeled loader with tanks 5 arranged horizontally, with the pivot or rotation axis about which the tank sum 5 is pivotable extending vertically. The pivot range of the tank system is also shown here by 11 and the wheel well of the wheeled loader is shown by 12. Reference numeral 13 marks the hydrogen supply line or another fuel supply line.

1. A work machine having at least one container for receiving a fuel that serves the propulsion of the work machine and/or for the drive of a machine component, wherein an assembly is provided that comprises a rack in which the container is received and that furthermore has a plating for the mechanical protection of the container located in the rack.

2. A work machine having at least one container for receiving a fuel that serves the propulsion of the work machine and/or for the drive of a machine component, wherein a rack is provided in which the container is arranged; and a pivot or folding mechanism is present by means of which the rack is arranged pivotably or foldably at the work machine.

3. A work machine having at least one container for receiving a fuel that serves the propulsion of the work machine and/or for the drive of a machine component, wherein the work machine has one or more wheel arches, wherein a rack is provided in which the container is arranged; and the rack is arranged above the wheel arch or arches of the work machine.

4. A work machine in accordance with claim 1, wherein a fixed position fuel pipeline system is present; and a flexible tube piece is provided that connects this fixed position pipeline system to the container or to the rack.

5. A work machine in accordance with claim 6, wherein the pivot or fold mechanism is either manually movable; and/or a mechanism is present to actuate the pivot or folding mechanism that is supported by external force.

6. A work machine in accordance with claim 7, wherein the axis of the pivot or folding mechanism extends horizontally, vertically, or obliquely.

7. A work machine in accordance with claim 1, wherein the rack is configured to receive a mechanical deformation of the container.

8. A work machine in accordance with claim 1, wherein the assembly is configured as a preinstallation assembly; and/or the assembly is formed in one part or consisting of a plurality of elements.

9. A work machine in accordance with claim 1, wherein the fuel system has a high pressure part; and all the components of the high pressure part are arranged in the rack or in the assembly.

10. A work machine in accordance with claim 1, wherein the container serves the reception of a gaseous fuel and/or the reception of a fluid fuel or is filled therewith.

11. A work machine in accordance with claim 1, wherein the work machine is a travelable work machine and in particular a wheeled loader, a bulldozer and a crawler-mounted loader, a crawler excavator and a wheeled excavator, an articulately linked dump truck and rigid frame truck, or a telescopic loader.

12. A work machine in accordance claim 1, wherein the work machine has a fuel cell or an internal combustion engine for the propulsion of the work machine or for the supply of consumers of the work machine.
